(19) United States
(12) Patent Application Publication
(10) Pub. No.: US 2009/0080631 A1
(43) Pub. Date: Mar. 26, 2009

(54) METHOD, APPARATUS AND COMMUNICATION SYSTEM FOR RENTING TELEPHONE NUMBER

(75) Inventors: Deyong LIU, Shenzhen (CN); Liang CHEN, Shenzhen (CN)

Correspondence Address: Leydig, Voit & Mayer, Ltd;(for Huawei Technologies Co., Ltd), Two Prudential Plaza Suite 4900, 180 North Stetson Avenue, Chicago, IL, 60601, US

(73) Assignee: HUAWEI TECHNOLOGIES CO., LTD., Shenzhen (CN)

(21) Appl. No.: 12/210,019

(22) Filed: Sep. 12, 2008

Related U.S. Application Data
(63) Continuation-in-part of application No. PCT/CN2007/000499, filed on Feb. 13, 2007.

(30) Foreign Application Priority Data
Mar. 14, 2006 (CN) 200610064837.8

(51) Int. Cl. H04M 3/42

(52) U.S. Cl. 379/201.12

(57) ABSTRACT

A method for renting a telephone number includes: receiving the request for renting a telephone number sent by the request user through the host number; selecting at least one telephone number as the rented number of the request user according to the request; binding the rented number with the host number of the request user. In the present invention, renting a telephone number could be realized by performing the steps such as receiving the request for renting a telephone number, selecting at least one telephone number as the rented number and binding the rented number with the host number of the request user terminal. Thus, users could rent a telephone just by sending a request for renting a number instead of going to the business hall in person to handle the number renting service, so the time cost by handling the service could be saved.

### CROSS-REFERENCE TO RELATED APPLICATION

This application is a continuation-in part of International Patent Application No. PCT/CN2007/000499, filed Feb. 13, 2007, which claims priority to Chinese Patent Application No. 200610064837.8, filed Mar. 14, 2006, each of which is hereby incorporated by reference in its entirety.

### FIELD OF THE INVENTION

The present invention relates to communication technologies, and particularly, to the phone number renting technology.

### BACKGROUND OF THE INVENTION

Due to personal privacy or other reasons, a person often needs multiple mobile phone numbers in daily life. For example, a business person needs to use one mobile phone number for communication with friends and families and another one for communication with clients. Therefore, while keeping a primary number, the person may use other phone numbers for communication. Thus, a single mobile phone may be provided with multiple mobile phone numbers. Currently, there are primarily two methods to achieve a single mobile phone with multiple phone numbers.

According to a first method, a user purchases a mobile phone that may be loaded with a plurality of Subscriber Identity Modules (SIMs), e.g. single phone with dual SIM. In this method, the user has to spend money purchasing the special mobile phone, and can only obtain a limited number of phone numbers due to the limited number of the loaded SIM cards. Further, the use of multiple numbers may result in a reduced value of Average Revenue Per User (ARPU). Consequently, due to the drawbacks of this method, a very limited number of consumers adopt this method to obtain a single mobile phone with multiple phone numbers.

According to a second method, the user does not have to replace his mobile phone, but only needs to go to a business branch of a mobile operator and apply for renting one or more Mobile Subscriber International ISDN (MSISDN) numbers, i.e. single card multiple numbers. This method is also referred to as phone number renting method. In this method, the user needs to go to the business branch and register the service of single card multiple numbers by himself, and the service staff selects at least one phone number from a database in which idle phone numbers are stored, and binds the at least one phone number, after being confirmed by the user, with the original SIM card of the user. This method is more commonly used at present in implementing the service of single phone multiple numbers. However, the user who uses this method has to go to the business branch for registration of the service in person, and will have to go to the business branch again in person if he wishes to change a phone number or function of the phone number during the use of the service. This is obviously not time-effective in such an era when people have to rush to do everything against time. In addition, the value of user APRU will be reduced inevitably due to concurrent use of a plurality of numbers. As can be seen from above, the existing phone number renting methods are time-consuming for users.

### SUMMARY OF THE INVENTION

Embodiments of the present invention provide a phone number renting method and device, a Service Control Point (SCP), a communication system, and a calling method, so as to reduce the time a user spends in renting a phone number.

To this end, an embodiment of the invention provides a phone number renting method including: receiving a phone number renting request sent from a requester using a primary number; selecting at least one phone number as a rented number of the requester in accordance with the request; and binding the rented number with the primary number of the requester.

An embodiment of the invention further provides a phone number renting device including: a request receiving unit adapted to receive a phone number renting request sent from a requester using a primary number; a rented number selecting unit adapted to select at least one phone number as a rented number of the requester in accordance with the request; and a processing unit adapted to store information on binding of the rented number and the primary number of the requester.

An embodiment of the invention further provides a service control point SCP including: a request receiving unit adapted to receive a phone number renting request sent from a requester using a primary number; a rented number selecting unit adapted to select at least one phone number as a rented number of the requester in accordance with the request; and a processing unit adapted to store information on binding of the rented number and the primary number of the requester.

An embodiment of the invention further provides a communication system including a SCP, in which the SCP includes: a request receiving unit adapted to receive a phone number renting request sent from a requester using a primary number; a rented number selecting unit adapted to select at least one phone number as a rented number of the requester in accordance with the request; and a processing unit adapted to store information on binding of the rented number and the primary number of the requester.

An embodiment of the invention further provides a call method including: establishing a call control relationship with a service control point when a call is originated from a primary number or when a call is received by a rented number; and obtaining, by the service control point, call control information in accordance with information on binding of the primary number and the rented number, which is stored in advance, and controlling the call in accordance with the call control information.

According to embodiments of the invention, the phone number renting can be achieved by the steps of receiving a phone number renting request, selecting at least one phone number as a rented number and binding the rented number with a primary number of the user terminal sending the request. Thus, the user can rent a phone number by simply sending a number renting request; therefore, it is needless to go to a business branch to obtain a number renting service by himself, thereby saving the time the user spends in obtaining the service.

### BRIEF DESCRIPTION OF THE DRAWINGS

FIG. 1 is a flow chart of the method according to an embodiment of the invention;

FIG. 2 is a flow chart of implementation of step S103 in FIG. 1;

FIG. 3 is a flow chart of the method according to another embodiment of the invention;

FIG. 4 is a flow chart of the method according to another embodiment of the invention;

FIG. 5 is a flow chart of a subsequent operations after completion of step S404 in FIG. 4;

FIG. 6 is a flow chart of another subsequent operations after completion of step S404 in FIG. 4; and

FIG. 7 is a flow chart of managing lifecycle of a rented number according to an embodiment of the invention.

FIG. 8 is a schematic diagram showing the structure of a phone number renting device according to an embodiment of the invention;

FIG. 9 is a schematic diagram showing the structure of a communication system according to an embodiment of the invention.

### DETAILED DESCRIPTION OF THE INVENTION

The embodiments of the invention are described in detail hereinafter by reference to the drawings.

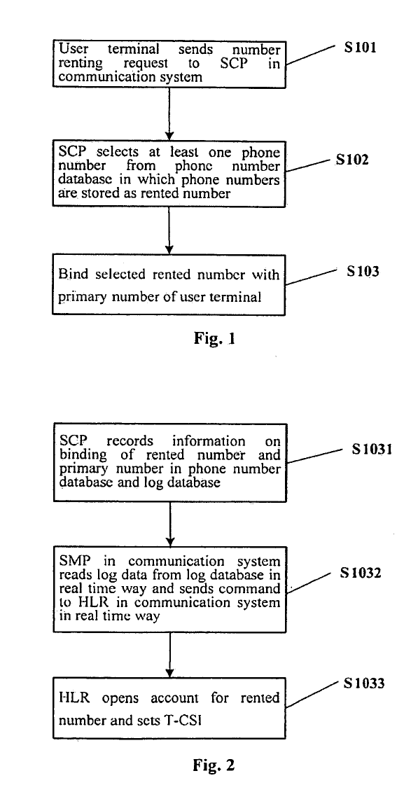

A method according to an embodiment of the invention will be described with reference to FIG. 1. As illustrated in FIG. 1, the embodiment of the method includes:

Step S101: A user terminal sends a number renting request to a Service Control Point (SCP) in a communication system.

Specifically, the user terminal here may be a mobile phone, a fixed phone, or a computer terminal, etc. The terminal may send a number renting request to the SCP through an Interactive Voice Response (IVR) system, Unstructured Supplementary Service Data (USSD), Internet or a Wireless Application Protocol (WAP) system. The request may be in various forms such as voice or short message, or may be input by logging into a network, etc. The user terminal may request to rent one number, and may also request to rent more than one number. In the request, the user terminal may also set requirements for a rented number. For example, the user terminal may specify the last digit of the number or specify at least one complete phone number, etc.

Step S102: The SCP selects at least one phone number from a phone number database according to the number renting request, in which phone numbers are stored, as the rented number.

Specifically, after receiving the renting request, the SCP searches the idle number database for a phone number in an idle state in accordance with the number renting request of the user terminal. For example, if the user terminal requests to rent three numbers, the SCP searches the idle number database for three numbers in the idle state; and if the user terminal requests numbers with the last digit 6, the SCP searches the idle number database and finds the requested numbers which last digit is 6.

Step S103: The selected rented number is bound with a primary number of the user terminal.

After finding the idle number, the SCP binds the idle number with the primary number of the user terminal. The number renting procedure is thus finished.

Step S103 is described as an example in detail below by reference to FIG. 2. The step S103 may include:

Step S1031: The SCP records information on binding of the rented number and the primary number in a phone number database and a log database.

Step S1032: A Service Management Point (SMP) in the communication system reads log data from the log database in a real time way and sends a command to a Home Location Register (HLR) in the communication system in a real time way.

Step S1033: The HLR opens an account for the rented number and sets Termination-CAMEL Subscription Information (T-CSI).

Particularly, an interface between the SMP and the HLR may be a real time interface based upon the Transmission Control Protocol (TCP)/Internet Protocol (IP). For example, a Man-Machine Language (MML) interface can be adopted.

Further, an interactive authentication process of the SCP and the user terminal may be added between step S101 and step S102. The interactive authentication is intended to determine whether the user terminal has a right to apply for a rented number, and if the user terminal has the right to apply, the flow goes to the step S102; otherwise, the user is notified that the number renting service cannot be provided to the user terminal.

Further, an additional step may also be added after the step S102, in which the rented number is provided to the user terminal who sends the request, so as to make the user terminal clearly aware of the rented phone number.

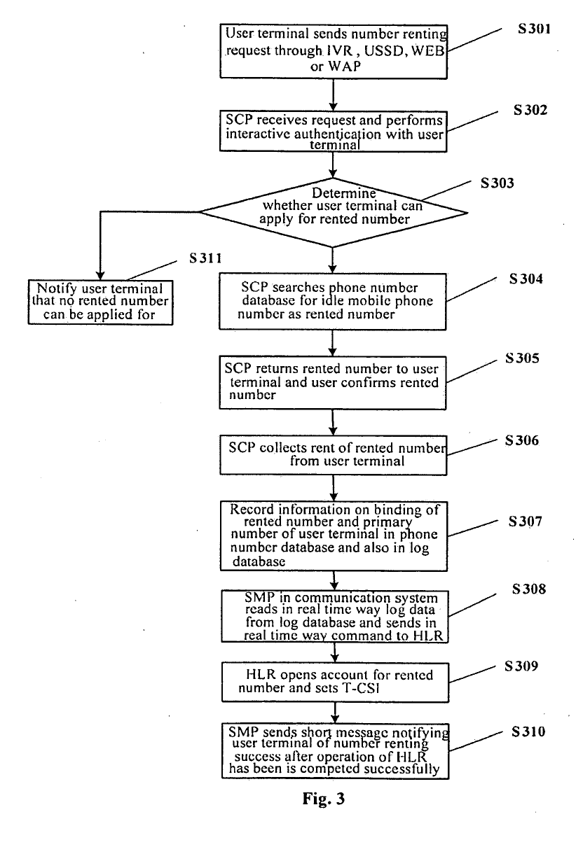

A method according to another embodiment of the invention will be described below with reference to FIG. 3. As illustrated in FIG. 3, the method includes:

Step S301: The user terminal sends a number renting request through IVR, USSD, WEB, or WAP.

Step S302: A SCP receives the request and performs interactive authentication with the user terminal.

Step S303: It is determined whether the user terminal can apply for a rented number, and if the user terminal can apply, the flow goes to the step S304; otherwise, the flow goes to the step S311.

Step S304: The SCP searches the phone number database for an idle mobile phone number as the rented number.

Step S305: The SCP returns the rented number to the user terminal and the user confirms the rented number.

Step S306: The SCP collects rent for the rented number from the user terminal.

Step S307: The information on binding of the rented number and a primary number of the user terminal is recorded in a phone number database and also in a log database.

Step S308: A SMP reads log data from the log database in a real time way and sends a command to the HLR in a real time way.

Step S309: The HLR opens an account for the rented number and sets T-CSI. An interface between the SMP and the HLR is a TCP/IP based real time interface, such as a standard MML interface.

Step S310: After the HLR has performed the above operations successfully, the SMP sends a short message notifying the user terminal of success of the number renting.

Step S311: The user terminal is notified that it cannot apply for a rented number.

In order to address the problem that concurrent use of a plurality of numbers results in a reduced value of APRU, the invention further provides another embodiment, based upon the above two embodiments of the method.

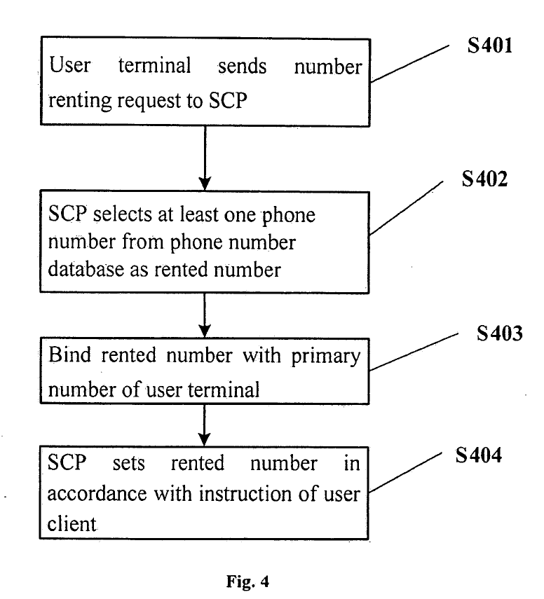

The method according to this another embodiment of the invention will be described below with reference to FIG. 4. As illustrated in FIG. 4, the embodiment of the method includes:

Step S401: A user terminal sends a number renting request to a SCP. The user terminal here may be a mobile phone, a fixed phone, a computer terminal, etc. The terminal may send a number renting request to the SCP through an IVR system, USSD, Internet, or a WAP system. The request may be in a form of voice or short message, or may be input by logging in to a network, etc. The user terminal may request to rent one number, or to rent more than one number. In the request, the user terminal may also set requirements for a rented number. For example, the user terminal may specify the last digit of the phone number, or specify at least one complete phone number, etc.

Step S402: The SCP selects at least one phone number from a phone number database as the rented number.

The SCP, after receiving the renting request, searches the phone number database for a phone number in an idle state in accordance with the request of the user terminal. For example, if the user terminal requests to rent three numbers, the SCP searches the phone number database for three numbers in the idle state; and if the user terminal requests for a number with the last digit 6, the SCP searches the phone number database for an idle number which last digit is 6 and finds the requested number.

Step S403: The rented number is bound with a primary number of the user terminal. The SCP, after finding the idle number, binds the idle number with the primary number of the user terminal.

Step S404: The SCP sets the rented number in accordance with an instruction of the user terminal. In this step, the user terminal may send to the SCP a rented number setting request including requirements for setting the rented number, i.e., how to deal with the rented number, and the SCP, after receiving the request, sets the rented number in accordance with the request.

In step S404, the user terminal may specify, through the IVR system, the USSD, Internet, or WAP system, on which user terminal the rented number will be displayed or which phone number will be displayed on an opposite user terminal during communication with the opposite user terminal. Because the user terminal is provided with at least two numbers after applying for the rented number successfully, and these numbers may have their respective uses, it is necessary to specify a phone number to be displayed on the opposite terminal. For example, he may use a specific number when he communicates with his families and friends and specify this number to be displayed on terminals of the families and friends; and the user may use another specific number for business communications and specifies this number to be displayed on terminal of his clients or colleagues.

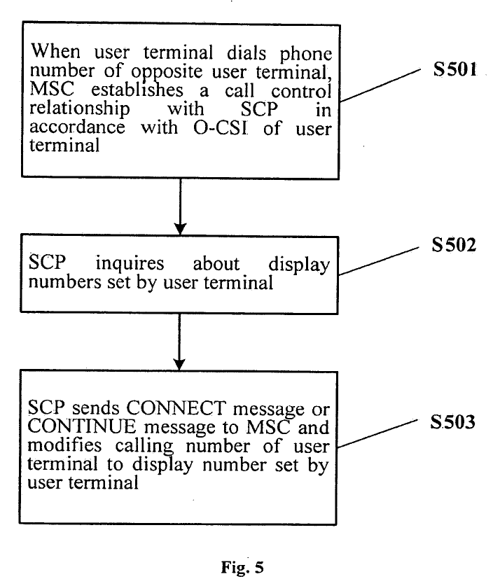

After the above step of specifying is finished, a phone number may be displayed on an opposite user terminal during communication with the opposite user terminal in accordance with the flow chart illustrated in FIG. 5. As illustrated in FIG. 5, the flow includes:

Step S501: When the user terminal dials the phone number of the opposite user terminal, a Mobile Switching Center (MSC) establishes a call control relationship with the SCP in accordance with the Originating-CAMEL Subscription Information (O-CSI). The user terminal may dial the phone number of the opposite user terminal and make a call using a primary number or using a rented number bound with the primary number.

Step S502: The SCP searches for a display number preset by the user terminal.

Step S503: The SCP sends a CONNECT message or a CONTINUE message to the MSC and modifies the calling number of the user terminal as the display number preset by the user terminal.

Step S404: The user terminal may also specify that each rented number is in a state of number accessibility, number inaccessibility or number nonexistence, through the IVR system, the USSD, the Internet or the WAP system. If the opposite terminal calls a user terminal at a number which is set in the accessibility state, the call can be put through to the user terminal; if the opposite terminal calls a user terminal at a number which is set in the inaccessibility state, the call may not be put through to the user terminal; and if the opposite terminal calls a user terminal at a number which is set in the number nonexistence state, the opposite terminal may be prompted with a tone that the number does not exist.

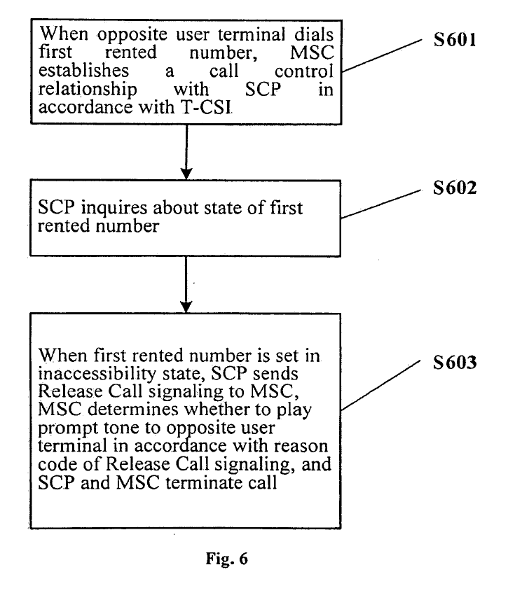

After the above specifying is completed and if the opposite user terminal initiates a call, subsequent call operations may be performed in accordance with the flow chart illustrated in FIG. 6. As illustrated, the flow includes:

Step S601: When the opposite user terminal dials a first rented number, the MSC establishes a call control relationship with the SCP through T-CSI.

Step S602: The SCP inquires about the state of the first rented number.

Step S603: When the first rented number is set in the number inaccessibility state, the SCP sends Release Call signaling to the MSC, and the MSC determines whether to play a prompt tone to the opposite user terminal in accordance with a reason code of the Release Call signaling. The SCP and the MSC terminate the call.

When the first rented number is set in the number inaccessibility state and is called, the SCP can send to the user terminal, particularly at the primary number, prompt information including the phone number of the opposite user terminal, the called first rented number and the time when the number is called. In this case, the SCP can send the prompt information that the first rented number is called to the user terminal at the primary number, through a Short Message Service Center (SMSC) in the Short Message Peer to Peer (SMPP) Protocol, and the prompt information includes the phone number of the opposite user terminal, the called first rented number and the time when the number is called.

In the step S404, the user terminal may also specify a period during which the rented number is accessible or not accessible. In this case, the user terminal can specify whether each number is in accessibility state or inaccessibility state during a certain period. For example, the user terminal can specify that no call can be put through to a certain number before 10:00 a.m. in a certain day.

In the step S404, the user terminal can also request to cancel at least one rented number through the IVR system, the USSD, the Internet or the WAP system.

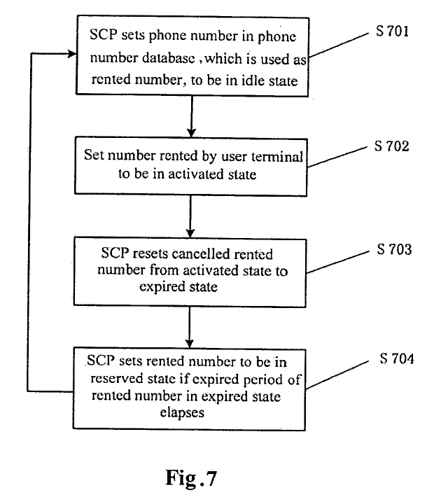

Further, an embodiment of the invention provides a technology of managing a lifecycle of a rented number. As illustrated in FIG. 7, the lifecycle of the rented number can be managed in the following steps.

Step S701: The SCP sets a phone number in the phone number database, which is used as a rented number, to be in an idle state. The number in the idle state can be rented to any user terminal which is authorized to apply for a rented number.

Step S702: The number that is rented to the user terminal is set to be in an activated state. Of course, the user terminal may be charged rent for renting the phone number, and the amount of the rent may vary from one phone number to another. The operator may charge the rent through a charging system.

Step S703: The SCP changes the state of a canceled rented number from the activated status to an expired status. The rented number in the expired status can be activated and used preferentially by the original user terminal, and if it is activated, the flow goes back to the step S702.

Step S704: If the expired period of the rented number in the expired status elapses, the SCP sets the rented number to be in a reserved status, and the rented number in reserved status cannot be rented to any user terminal. After the reserved period elapses, the number in the reserved status can be reset in an idle status, that is, the flow goes back to the step S701. Of course, if the expired period of the rented number in the expired status elapses, the SCP can set it directly to be in the idle status.

As can be seen from the above solution of managing periods of a rented number, the embodiment of the invention can make cyclic use of the rented number resources.

In the embodiment illustrated in FIG. 7, each step may be performed in combination with the embodiments illustrated in FIG. 1 to FIG. 6. For example, the step S701 may be performed after the user terminal sends the number renting request, the step S702 may be performed after the SCP selects the rented number for the user terminal, the step S703 may be performed after the user terminal requests to cancel the rented number, and also the step S704 may be performed after the user terminal requests to cancel the rented number.

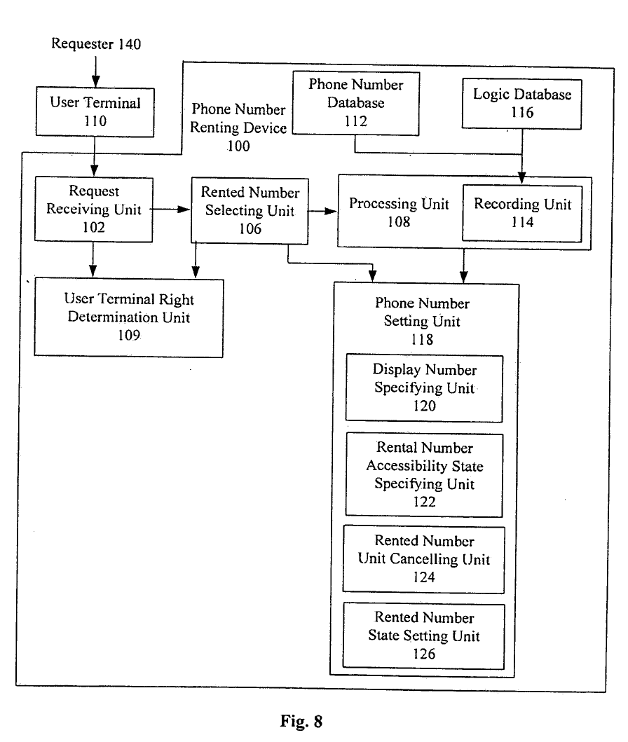

As shown in FIG. 8, an embodiment of the invention further provides a phone number renting device 100. The device 100 includes: a request receiving unit 102 adapted to receive a phone number renting request sent from a requester 104 using a primary number; a rented number selecting unit 106 adapted to select at least one phone number for the requester as a rented number of the requester in accordance with the request; and a processing unit 108 adapted to store information on binding of the rented number and the primary number of the requester.

The renting device 100 may further include a user terminal right determination unit 109 adapted to determine whether a user terminal 110 sending the request is authorized to apply for a rented number before the rented number selecting unit 106 selects the at least phone number as the rented number.

If the user terminal right determination unit 108 determines that the user terminal 110 is authorized to apply for a rented number, the rented number selecting unit 106 searches a phone number database 112 in which phone numbers are stored.

The processing unit 108 may include a recording unit 114 adapted to record the information on binding of the rented number and the primary number in the phone number database 112 and in a log database 116 for log records.

The renting device 100 may further include a phone number setting unit 118 adapted to set the rented number in accordance with an instruction of the user terminal.

The phone number setting unit 118 may include:

a display number specifying unit 120, adapted to specify whether the primary number or a rented number of the user terminal 110 is displayed on the opposite user terminal; and/or

a rented number accessibility state specifying unit 122, adapted to specify whether a rented number is in a state of number accessibility, number inaccessibility or number nonexistence, and/or a period during which the rented number is in the accessibility or inaccessibility state; and/or

a rented number unit cancelling unit 124, adapted to cancel at least one rented number.

The phone number setting unit 118 may further include:

a rented number state setting unit 126, adapted to set all un-rented phone numbers to be in an idle state before the rented number selecting unit selects the at least one phone number as the rented number; and/or to set at least one rented number to be in an activated state after the rented number selecting unit selects the at least one phone number as the rented number; and/or

to set at least one rented number to be in an expired state after the rented number unit cancelling unit cancels the at least one rented number, where the rented number in the expired state is activated and used preferentially by the user terminal; and/or

to set a rented number in an expired state to be in a reserved state after the expired period of the rented number elapses, where the rented number in the reserved state cannot be rented to any user terminal; and/or

to reset a rented number in the reserved state to be in the idle state after the reserved period of the rented number lapses.

An example of the phone number renting device 100 is a SCP, including: the request receiving unit 102 adapted to receive a phone number renting request sent from the requester 104 using a primary number; the rented number selecting unit 106 adapted to select at least one phone number for the requester as a rented number of the requester in accordance with the request; and the processing unit 108 adapted to store information on binding of the rented number and the primary number of the requester.

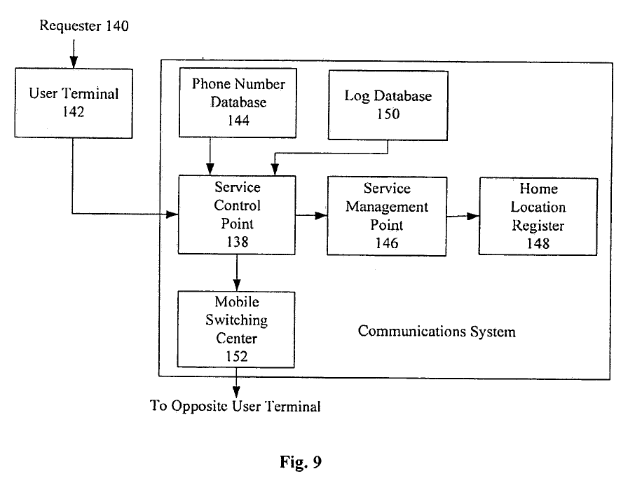

As shown in FIG. 9, an embodiment of the invention further provides a communications system 136 including a Service Control Point (SCP) 138, the SCP is adapted to receive a phone number renting request sent from a requester 140 using a primary number; to select at least one phone number for the requester as a rented number of the requester in accordance with the request; and to store information on binding of the rented number and the primary number of the requester.

The SCP 138 may, before selecting the at least one phone number as the rented number, determine whether a user terminal 142 sending the request is authorized to apply for a rented number, and if so, the SCP can search a phone number database 144 in which phone numbers are stored.

The communication system may further include a Service Management Point) (SMP) 146 and a Home Location Register (HLR) 148, and the SCP 138 can record the information on binding of the rented number and the primary number in the phone number database 144 and in a log database 150 for log records. The SMP 146 can read log data from the log database 150 in a real time way and sends a command to the HLR 148 in a real time way, and the HLR can open an account for the rented number and set Terminating-CAMEL subscription information.

The communication system 136 may further include a Mobile Switching Center (MSC) 152. If the user terminal 142 calls an opposite user terminal, the MSC 152 establishes a call control relationship with the SCP 138 in accordance with the originating-CAMEL subscription information of the user terminal; the SCP inquires about a phone number specified by the user terminal to be displayed on the opposite user terminal; and the SCP sends a CONNECT message or a CONTINUE message to the MSC and modifies the calling number of the user terminal to be the phone number specified to be displayed on the opposite user terminal.

If the opposite user terminal dials a first rented number of the user terminal 142, the MSC 152 establishes a call control relationship with the SCP 138 in accordance with terminating-CAMEL subscription information; the SCP inquires about the state of the first rented number, and if it is determined that the first rented number is set in a state of number inaccessibility, the SCP sends a Release Call signaling to the MSC; the MSC determines whether to play a prompt tone to the opposite user terminal in accordance with a reason code of the Release Call signaling; and the SCP and the MSC terminate the call.

It shall be noted that the embodiments of the invention can be based upon a standard wireless intelligent network system, and none of network devices (e.g., the MSC/HLR/BSS) in the wireless intelligent network system is required to be updated. Interfaces between various network devices or function entities are all standard interfaces.

In the embodiments of the invention, the secured and efficient operation of the system can be ensured by the steps of performing interactive authentication with a user terminal and determining whether the user terminal is authorized to apply for this service before the user terminal applies for a rented number.

In the embodiments of the invention, the rented number can be set in accordance with an instruction of the user terminal, so that the user terminal can control the rented number flexibly and actively, and can also be provided with various convenient and practical services.

In the embodiments of the invention, because the rented number, particularly the periods of the rented number, can be managed effectively, a cyclic use of phone numbers can be achieved, thus avoiding a waste of the phone number resources and improving the APRU.

The foregoing descriptions are merely illustrative of the exemplary embodiments of the invention and it shall be appreciated that those ordinarily skilled in the art can also make numerous modifications and variations without departing from the spirit of the invention and that these modifications and variations shall also be considered as falling within the scope of the invention.

What is claimed is:

1. A method for renting a phone number, comprising:
receiving a phone number renting request sent from a requester using a primary number;
selecting at least one phone number as a rented number of the requester in accordance with the request; and
binding the rented number and the primary number of the requester.

2. The method according to claim 1, wherein the phone number renting request is sent by the requester through an interactive voice response system, unstructured supplementary service data, Internet, or a wireless application protocol system.

3. The method according to claim 1, wherein the process of selecting the at least one phone number as the rented number comprises determining whether the requester is authorized to apply for a rented number, and if the requester is authorized to apply for a rented number, selecting a rented number for the requester from a phone number database in which phone numbers are stored.

4. The method according to claim 1, wherein the selected rented number is a phone number in an idle state.

5. The method according to claim 1, wherein the process of binding the rented number and the primary number of the requester comprises: storing information on the binding of the rented number and the primary number; and sending the information to a home subscriber register to open an account for the rented number.

6. The method according to claim 1, further comprising: after selecting at least one phone number as the rented number, setting the rented phone number to be in an activated state.

7. The method according to claim 1, further comprising: after binding the rented number and the primary number of the requester, setting the rented number in accordance with an instruction of the requester.

8. The method according to claim 7, wherein the instruction of the requester comprises specifying the primary number of the requester or the rented number to be displayed on an opposite user terminal.

9. The method according to claim 7, wherein the process of setting the rented number comprises: specifying that each rented number is in a state of number accessibility, number inaccessibility or number nonexistence.

10. The method according to claim 9, further comprising: specifying a period during which each rented number is in the state of number accessibility or number inaccessibility.

11. The method according to claim 7, wherein the process of setting the rented number comprises: cancelling at least one rented number.

12. The method according to claim 11, further comprising: after cancelling at least one rented number, setting the cancelled rented number to be in an expired state, wherein the rented number in the expired state is activated and used preferentially by the requester.

13. The method according to claim 12, further comprising: after setting the cancelled rented number to be in the expired state, setting the rented number to be in a reserved state after an expired period elapses, wherein the rented number in the reserved state cannot be rented by any requester.

14. The method according to claim 13, further comprising: setting the rented number to be in an idle state when a reserved period of time elapses after the rented number is set in the reserved state.

15. A phone number renting device, comprising:
a request receiving unit, adapted to receive a phone number renting request sent from a requester using a primary number;
a rented number selecting unit, adapted to select at least one phone number as a rented number of the requester in accordance with the request; and
a processing unit, adapted to store information on binding of the rented number and the primary number of the requester.

16. The phone number renting device according to claim 15, further comprising:
a user terminal right determination unit, adapted to determine whether a user terminal sending the request is authorized to apply for a rented number before the rented number selecting unit selects the at least phone number as the rented number; and/or
a phone number setting unit, adapted to set the rented number in accordance with an instruction of the user terminal.

17. A communication system, comprising a service control point (SCP), wherein the SCP is adapted to receive a phone number renting request sent from a requester using a primary number; adapted to select at least one phone number as a rented number of the requester in accordance with the request; and adapted to store information on binding of the rented number and the primary number of the requester.

18. The system according to claim 17, wherein the SCP is further adapted to record the information on binding of the rented number and the primary number in the phone number database and in a log database for log records;
the system further comprising a Service Management Point (SMP) and a Home Location Register(HLR), the SMP is adapted to read log data from the log database in a real time way and to send a command to the HLR in a real time way, and the HLR is adapted to open an account for the rented number and set Terminating-CAMEL subscription information.

19. A call method, comprising:
establishing a call control relationship with a service control point (SCP) when a call is originated from a primary number or a call is received by a rented number, wherein the rented number is selected in accordance with a request phone number renting request sent from a requester using the primary number; and
obtaining, by the SCP, call control information in accordance with information on binding of the primary number and the rented number, which is stored in advance, and controlling the call in accordance with the call control information.

20. The call method according to claim 19, wherein if a call control relationship with the service control point is established when a call is originated from the primary number, the controlling of the call by the SCP in accordance with the call control information comprises:
determining a phone number specified by the calling user to be displayed on an opposite user terminal; and
if the specified phone number is the rented number, sending a connect message or a continue message, and changing the calling number that is used to originate the call from the primary number to the rented number.
